(19) United States
(12) Patent Application Publication
(10) Pub. No.: US 2022/0094179 A1
(43) Pub. Date: Mar. 24, 2022

(54) MODULAR BATTERY SYSTEM

(71) Applicant: Tanktwo Oy, Vantaa (FI)

(72) Inventors: Juha Tuomola, Vantaa (FI); Timo Rissanen, Helsinki (FI); Heikki Juva, Vantaa (FI)

(21) Appl. No.: 17/421,238

(22) PCT Filed: Jan. 6, 2020
(86) PCT No.: PCT/EP2020/050136

§ 371 Date: Jul. 7, 2021

(30) Foreign Application Priority Data
Jan. 7, 2019 (GB) 1900194.0

(51) Int. Cl. H02J 7/00; B60L 3/00; B60L 58/19; H01M 10/42

(52) U.S. Cl. CPC H02J 7/0024; B60L 3/0046; B60L 2240/547; H01M 10/425; H01M 10/4207; B60L 58/19

(57) ABSTRACT

A battery system comprising a plurality of electrically coupled battery modules and a controller. Each module comprises a positive module terminal and a negative module terminal for electrically coupling with terminals of other modules, one or more module layers each comprising three or more battery cells arranged logically as a ring such that each battery cell has two neighbouring cells in the ring, and switches between neighbouring cells of a ring and between the cells and the positive and negative module terminals. The switches are configurable by said controller to electrically couple any two or more neighbouring battery cells of the ring in series between the positive and negative module terminals.

### TECHNICAL FIELD

The present invention relates to modular battery systems for storing electrical energy, and to methods of using such systems. In particular, though not necessarily, the invention relates to a battery system comprising a plurality of battery modules configurable to provide a voltage and power output from one of a set of available discrete voltage and power outputs.

The invention can be used in connection with intelligent battery systems for electric vehicles, but also in the fields of mobile electrical appliances, energy management, energy trading, routing and communication, to mention some examples.

### BACKGROUND

There are many high power applications that require the use and configuration of battery systems that comprise a large number of electric battery cells coupled together. Electric Vehicles (EVs) are one example. These applications can require a range of different voltages and power outputs for operation. Examples of configurable battery systems are disclosed in US 2014/0203650, US 2014/0312828, US 2016/064160, US 2014/015488 and US 2012/0319493. Typically, in these existing configurable battery systems, a number of battery cells are selectively connected in series or parallel, or a combination of series and parallel, to form a ‘branch’ or ‘string’. The number of cells connected in the string determines the voltage and power supplied. A plurality of strings can also be connected selectively in parallel to vary the power output. Reference is also made to the “string cell” concept created by Tanktwo Oy, Espoo Finland, as exemplified by WO2015/036437.

Generally, configurable battery systems of fixed construction appear to suffer from the drawback that each cell is only selectively connectable in series to one or two adjacent cells within a string. This limits the number of configurations that the cells can be selectively connected in, and hence limits the possible combinations of voltage and power outputs which can be supplied. In other words, the paths through which currents can flow are very limited and not particularly flexible.

For example, a maximum voltage is provided when every cell in a string is connected. In order to selectively reduce the supplied voltage, one or more cells in each string must be disconnected or bypassed—resulting in one or more redundant cells, and hence a reduced power output. It may be desirable to reduce the voltage output without reducing the total number of cells connected. Thus, there is a need for a more flexible, reconfigurable battery framework.

Furthermore, the aforementioned configurable battery systems (e.g. US 2014/015488) can suffer from the problem that, if a given cell within a string fails, the entire string can become non-operational. US 2012/0319493 attempts to solve this problem by providing each cell with a bypass switch, thereby allowing a non-functioning cell to be bypassed. This however introduces extra electronics, increasing costs and the complexity of the system. There is therefore a need for a configurable battery system which can provide an alternative to, or which can supplement, bypass switches.

A further common problem with current rechargeable battery systems is the long charging time. In a typical case, charging requires many hours. A solution to this problem is provided by modular battery systems. In these systems, if one module needs to be recharged, it can be removed and replaced with a fully charged module. Therefore, there is a need for a modular system, wherein any given module can quickly and easily be removed and replaced.

### SUMMARY

It is an objective to solve at least some of the above mentioned problems, and to provide a novel solution of providing electric energy to electrical devices and systems. A particular aim is to provide a novel system of selectively connectable cells forming a battery module. A further aim is to provide system of connectable battery modules. A still further aim is to provide a system that is able to cope with the failure of one or a limited number of cells without significantly reducing electrical supply capacity.

The solution proposed here is based on the idea of providing multiple connected battery modules, each module comprising a reconfigurable network of battery cells which may be rechargeable. The cells are coupled together and to module terminals via conductors and switches to form a network. The switches are operated by a controller, allowing dynamic reconfiguration of the network of connected cells, such that the electrical energy can be supplied by the module via a number of different paths, depending on the configuration of said switches.

Embodiments presented here may provide considerable advantages. The modules described herein can be used for forming an energy source for EVs or other systems that use electrical power. Although an individual module can be used as a power source, in a typical case, several modules can be connected together to provide a larger source of power. These modules can be connected in series or parallel or in a parallel and series combination.

The invention is generic in nature. It can be of great benefit also to other devices and systems that need, or can benefit from, a source of electrical power. Examples include power tools, mobile medical stations, military deployment units, aircraft, construction machinery, warehouse logistics robots, and more.

According to a first aspect of the invention there is provided a battery system comprising a plurality of electrically coupled battery modules and a controller. Each module comprises a positive module terminal and a negative module terminal for electrically coupling with terminals of other modules, one or more module layers each comprising
three or more battery cells arranged logically as a ring such that each battery cell has two neighbouring cells in the ring, and
switches between neighbouring cells of a ring and between the cells and the positive and negative module terminals.
   The switches are configurable by said controller to electrically couple any two or more neighbouring battery cells of the ring in series between the positive and negative module terminals.

The battery system may be configured such that current can flow between neighbouring cells of a module layer in only a single direction around the ring.

The switches may be configurable to disconnect one or more of the cells from a current path through the module layer. The controller may be configured to detect failure of one or more cells and to configure said switches to disconnect the one or more failed cells from a current path.

The switches may be configurable to provide two or more parallel current paths through the module layer.

The switches may comprise, for each battery cell, a first switch being configurable to couple a positive cell terminal to the positive module terminal or a negative terminal of another module layer, and a second switch being configurable to couple a negative cell terminal to the negative module terminal or a positive terminal of another module layer.

Each switch may be a two-way switch or a three-way switch in the sense that a single input can be switched between two or three outputs.

The battery system may comprise a plurality of said module layers, wherein the plurality of module layers are coupled in series. Alternatively, the plurality of module layers may be coupled such that each battery cell of a given module layer is coupled in series, via said switches, to a corresponding battery cell of one or more adjacent module layers. In a further alternative, the battery may be configured such that common terminals of all of the cells of a layer can be connected, via said switches, to a common point.

The switches may be configurable by the controller to electrically couple two or more non-neighbouring cells of a ring between the positive and negative module terminals.

One or more of the battery cells of a module layer may belong to two or more rings.

Each battery cell of a module layer may additionally be coupled to one or more non-neighbouring cells via switches.

According to a second aspect of the invention there is provided a method of operating the battery system according to the above first aspect and comprising configuring the switches, by means of said controller, to electrically couple all cells of the module, or all working cells, into a single series connected string of cells.

According to a third aspect of the invention there is provided a method of operating the battery system according to the above first aspect and comprising configuring the switches, by means of said controller, to connect a given subset of the cells of the module into a series connected string of cells in order to provide a required voltage and current output from the module. A plurality of such strings may be established across the module, with the plurality of strings being coupled in parallel between the positive and negative module terminals.

In the context of these aspects of the invention, the term “string” is used merely to identify a set of series connected cells.

According to a fourth aspect of the invention there is provided a method of operating the battery system according to the above first aspect and comprising configuring the switches, by means of said controller, to disconnect one or more failed cells of a module layer from other cells of the layer, and physically replacing the failed cells with one or more working cells.

### BRIEF DESCRIPTION OF THE DRAWINGS

FIG. 1 illustrates schematically components of a battery system;

FIG. 2 illustrates schematically a single cell layer of the system of FIG. 1;

FIG. 3 illustrates schematically a module of the system of FIG. 1 comprising two module layers;

FIGS. 4A to 4D illustrate schematically various operating configurations of the module of FIG. 3 in which all cells are functioning correctly;

FIGS. 5A to 5D illustrate schematically various operating configurations of the module of FIG. 3 in which one or more cells have failed;

FIG. 6 illustrates an operating configuration of a two-layer module where the module layers are coupled in series;

FIG. 7 is a virtualised configuration of a multi-layer module.

FIG. 8A illustrates schematically a single cell layer, in which each cell is coupled to every other cell of the layer;

FIG. 8B is a virtualised configuration of a multi-layer module, comprising multiple cell layers of FIG. 8A;

FIG. 9 is a virtualised configuration of a multi-layer module with multiple-ring topology; and

FIGS. 10 to 12 are flow diagrams illustrating various methods of operating a modular battery system.

### DETAILED DESCRIPTION

The following definitions may be helpful in understanding the description which follows.

“Battery” is a generic term for a device which stores energy, and should not be considered to be limiting. For example, the battery system may comprise electrochemical cells, or cell arrays, or supercapacitors, or supercapacitor arrays. Alternatively, the battery system may comprise fuel cells or any other DC power sources. By way of example only, individual cells making up the battery system may have a capacity of 1 uWh to 1 kWh.

A pair of “logically neighbouring” cells indicates that these cells are not necessarily physically neighbouring—but in terms of network topology they can be directly coupled via a conductor.

### System Overview

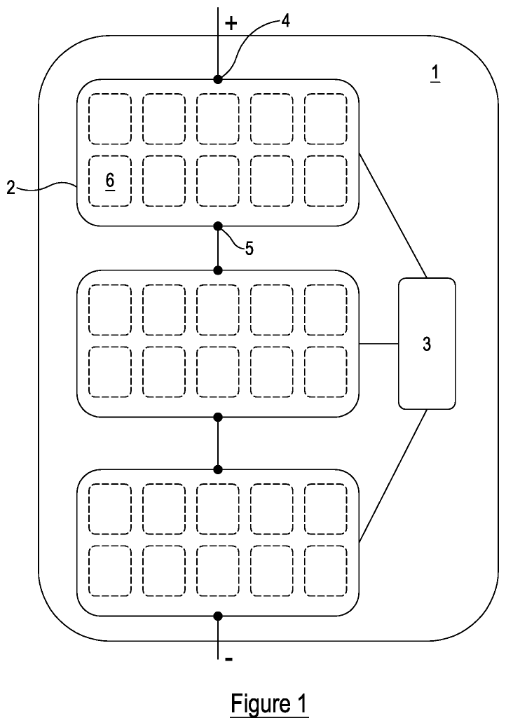

FIG. 1 is a block diagram of the main components of a battery system 1. The battery system 1 comprises a plurality of electrically connected battery modules 2, coupled to a controller 3. In FIG. 1, three series-connected modules are illustrated, although in principle any number of modules 2 could be connected in series or parallel, or in a combination of series and parallel. The modules 2 may be in the form of cartridges which are slotted into a rack of the battery system, with electrical connections between each module and the rack being formed by respective male and female connectors.

Each module 2 comprises a positive module terminal 4, a negative module terminal 5, and a plurality of battery cells 6 electrically coupled between these terminals 4, 5. Generally, “electrically coupled” or “coupled”, between these terminals 4, 5 means connected via one or more conductors or components, such that a current can flow between these terminals. The positive module terminal 4 and negative module terminal 5 allow a module 2 to be electrically connected to other modules in series. The positive module terminal 4 and negative module terminal 5 can also be coupled to an external device for charging the cells 6 within the module 2, or for connecting to a load for supplying power to said load. The controller 3, which may comprise a microprocessor and program and data memory, is able to electrically configure each module as will be described further below.

The battery cells 6 are arranged in one or more module layers, wherein each layer comprises three or more battery cells 6 arranged logically as a ring. The ring is formed by arranging the battery cells 6 such that a given battery cell 6 is coupled to two neighbouring battery cells 6 within the ring (where cells at the ends of a layer are considered to be neighbouring). One of the neighbouring battery cells 6 is coupled to the given battery cell's positive terminal, and the second neighbouring cell is coupled to the given battery cell's negative terminal. In this way, a closed loop, or ring of battery cells can be formed 6.

Each layer further comprises a plurality of switches (not shown in FIG. 1). The switches are preferably MOSFET switches although other switches may be used. Although not shown in the Figure, each of the switches is controlled by the controller 3. The switches allow any two or more neighbouring battery cells 6 within a layer to be selectively connected in series.

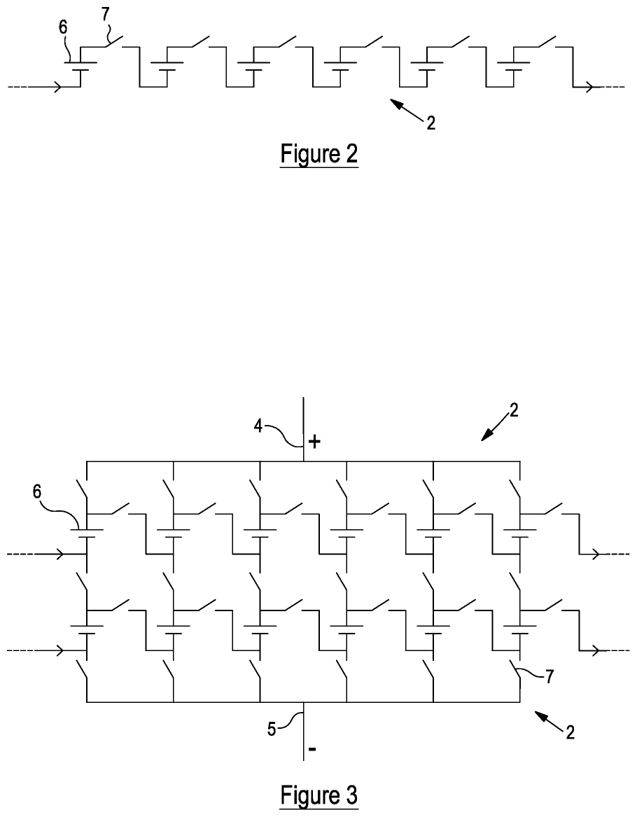

FIG. 2 illustrates an example layer having six battery cells 6, and six switches 7 interposed between said cells 6. A switch 7 is provided between the positive terminal of a given battery cell 6 and the negative terminal of the neighbouring battery cell 6, to which the positive cell terminal is coupled. In other words, each pair of battery cells 6 within the layer are selectively coupled (or decoupled), depending on the state of the switch. Generally, the state of a switch 7 can be open or closed. Conceptually, a current can flow out of the dashed section on the right hand side of the Figure, and into the dashed section on the left hand side, meaning the layer is topologically in the form of a ring. Although not shown in FIG. 2, further switches are used to connect the cells to the positive and negative module terminals and/or to neighbouring layers.

A module 2 includes one or more layers. By way of example, FIG. 3 illustrates an example module 2 having two of the six-cell layers of FIG. 2. Each battery cell 6 in a layer is further coupled to the logically neighbouring battery cell 6 in the layer above or, and to the positive or negative module terminal 4, 5. Further switches 7 are provided, coupled between battery cells 6 of the neighbouring layers, and between battery cells 6 and the positive module terminal 4 or negative module terminal 5.

In FIG. 3, all of the switches 7 of the module 2 are in an open state. Therefore, the battery cells 6 are decoupled from each other and from the module terminals 4, 5. In other words, every battery cell 6 is isolated. The switches 7 illustrated in FIG. 3, or a subset thereof, can be selectively closed to configure the module 2 in various different configurations. Each configuration provides a particular voltage and power output.

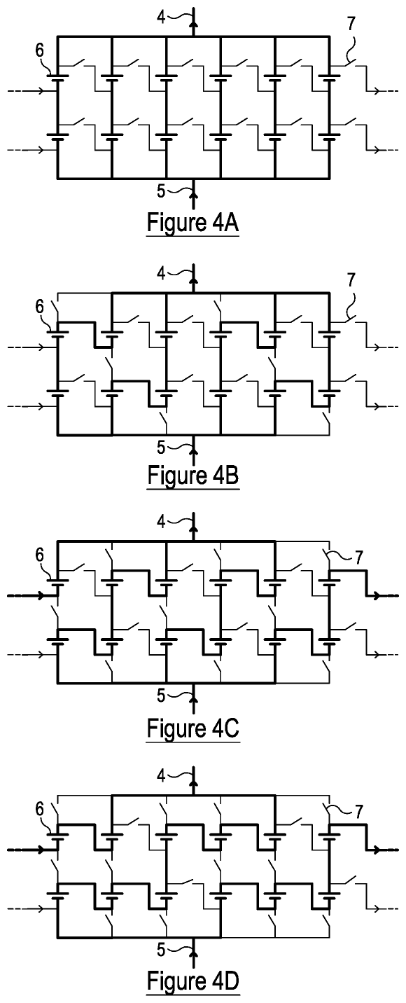

FIGS. 4A-D show example operating configurations of the two-layer module 2 of FIG. 3, wherein the battery cells 6 are connected in at least two parallel branches. In each Figure, the thick lines indicate two or more paths through which a current flows (i.e. routes where the switches 7 are closed).

In FIG. 4A, a subset of the switches 7 are closed such that the twelve battery cells 6 are connected in six parallel branches, each branch having two series-connected battery cells 6. In this case, the switches 7 between neighbouring battery cells 6 within a layer are open, and the remaining switches 7 are closed. If each battery cell 6 has a nominal voltage X, the output voltage provided by the module 2 is 2X, and the power utility is 100%. This configuration, involving the establishment of multiple cell stings connected in parallel if further illustrated by the method shown in FIG. 11.

In FIG. 4B, a different subset of switches 7 are closed, thereby configuring the module 2 in a configuration of four parallel branches, each branch having three series-connected battery cells 6. If each battery cell 6 has a nominal voltage X, the output voltage provided by the module 2 is 3X, and again the power utility is 100%.

In FIG. 4C, a different subset of switches 7 are closed, configuring the module 2 in a configuration of three parallel branches, each branch having four series-connected battery cells 6. If each battery cell 6 has a nominal voltage X, the output voltage provided by the module 2 is 4X, and again the power utility is 100%.

Finally, in FIG. 4D, a different subset of switches 7 are closed, configuring the module 2 in a configuration of two parallel branches, each branch having six series-connected battery cells 6. If each battery cell 6 has a nominal voltage X, the output voltage provided by the module 2 is 6X, and again the power utility is 100%.

The example module 2 is advantageous in that it can provide a number of different voltage outputs, as demonstrated. As such, a given module 2 can be used to supply power to a load requiring different voltages at different times. Alternatively, a given module 2 can be used to supply power to a range of different devices or loads, each requiring a different voltage.

It will be understood that the example configurations shown in FIGS. 4A-D are not exhaustive. It should also be understood that, generally, the module 2 can have more than two layers, with each layer having more (or less) than six battery cells 6 per layer. Having six, ten or twelve cells 6 per layer may be particularly advantageous as these numbers have a plurality of factors, meaning they naturally allow for a plurality of parallel configurations.

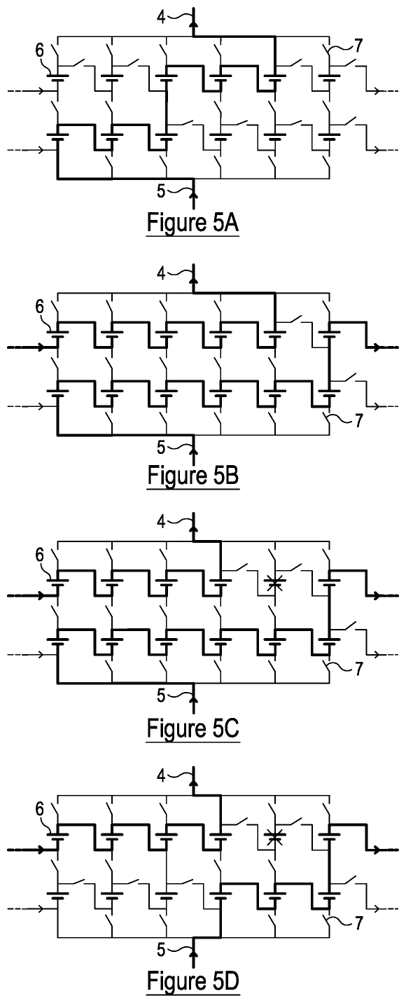

FIGS. 5A-C illustrate various further example configurations of the example module 2 of FIG. 3, wherein a number of the battery cells 6 are connected in series. Again, in the Figures, the thick line indicates the path through which the current flows (i.e. through a route where the switches 7 are closed).

The example module 2 permits any number of battery cells 6 between two and twelve battery cells 6 to be selectively connected in series, giving a power utility ranging from 16.7% to 100%. For example, in FIG. 5A a subset of the switches 7 has been closed, such that six of the twelve battery cells 6 present are connected in series. The remaining six the battery cells 6 are disconnected from the circuit. If each battery cell 6 has a nominal voltage X, the output voltage provided by the module 2 is 6X, and the power utility is 50%.

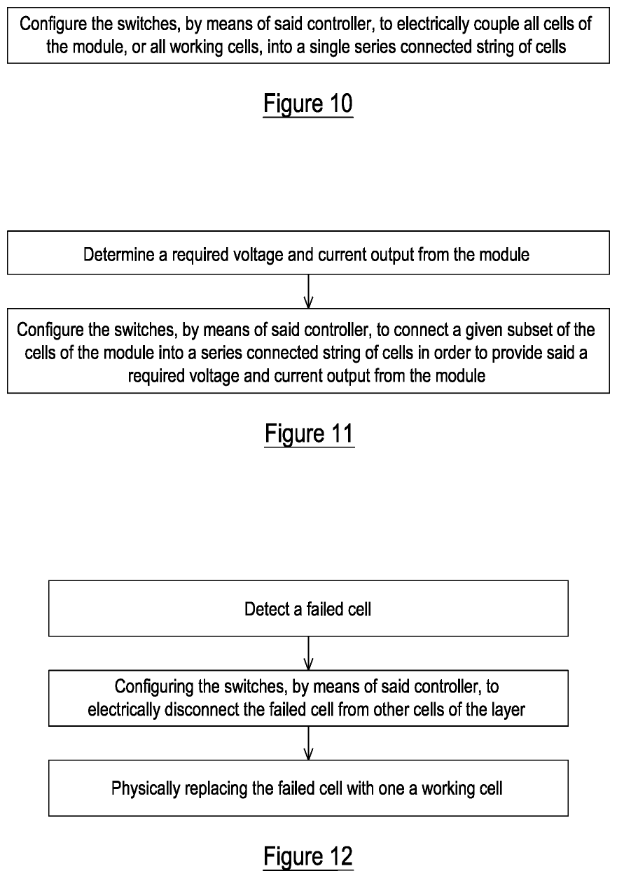

In FIG. 5B a different subset of the switches 7 is closed, such that all twelve battery cells 6 are connected in series. If each battery cell 6 has a nominal voltage X, the output voltage provided by the module 2 is 12X, and the power utility is 100%. This method of operating is further illustrated in FIG. 10.

The controller 3 may be configured to detect failure of a battery cell 6. Upon detecting failure of one or more battery cells 6, the controller 3 may configure the switches 7 to disconnect the one or more failed battery cells 6, while allowing a current to flow through some or all of the working battery cells 6. In this way, provided at least one battery cell 6 remains working in each layer, a current can flow between the positive and negative module terminals 4, 5, and a voltage and power output are provided.

Detecting failure of a battery cell 6 may include the controller 3 measuring and analysing one or more battery cell parameters, including the battery cell voltage, current through the battery cell, temperature, and how much charge remains in the battery cell.

The battery cell parameters may be measured periodically, for instance, every second.

The controller 3 may comprise a memory for storing information. Information stored may include the number of layers in each module 2, the number of battery cells 6 in a layer. Information stored may also include a status for each battery cell 6, indicating whether each battery cell 6 is working or has failed.

The controller 3 may be able to detect if a module 2 is added or removed from the battery system 1.

By way of example, in FIG. 5C, a single battery cell 6 is indicated as having failed (identified by a “X” superimposed over the cell). Suppose the module 2 is initially in the configuration as shown in FIG. 5B, with twelve series-connected battery cells 6, when the single battery cell 6 fails. The controller 3 detects failure of the single battery cell 6, and operates the switches directly 6 neighbouring the failed cell to selectively disconnect the failed cell from the network. The remaining switches 7 are operated such that the current flows through all the working battery cells 6.

Specifically, the switches 7 are operated by the controller 3 such that the current flows in to one of the battery cells neighbouring the failed cell in the same layer, and out of the other logically neighbouring cell, thereby passing through all of the operational cells 6 within the layer. In this way, only the failed cell is disconnected from the layer and the impact on the overall performance of the system is minimised.

FIG. 5D illustrates the case where a second battery cell 6 has failed. The controller 3 detects failure of the second failed battery cell 6, and reconfigures the switches 7 such the second failed cell is disconnected from the circuit, and such that the maximum possible number of working battery cells 6 is connected in series. In this particular example, eight battery cells are connected in series, giving a voltage of 8X and a power utility of 66.7%. The two battery cells 6 illustrated in the bottom right hand of the lower layer are no longer connected, despite these cells remaining operational. Nonetheless, the overall impact on system performance is minimised, while requiring only two or three switches 7 provided for a given battery cell 6.

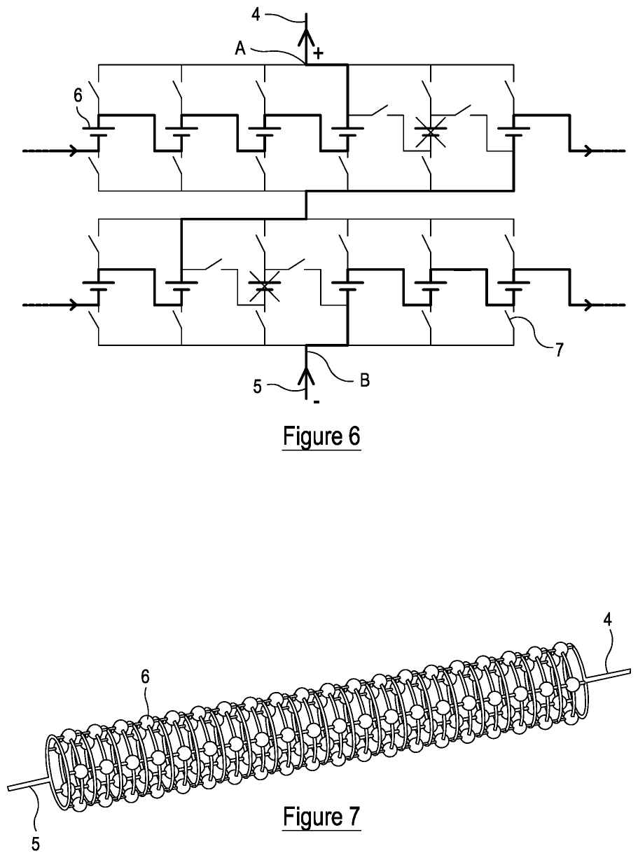

FIG. 6 illustrates a further example module 2, again having two layers of six battery cells 6. In this case however, the common, positive terminals of all of the cells 6 in the bottom layer are connected via further switches 7 to a first common point A. Likewise, the negative terminals of all of the cells 6 of the top layer are connected via further switches to a second common point B. This arrangement increases the number of switches 7 in the module 2 to three per battery cell 6.

In FIG. 6, two battery cells 6 are indicated as having failed, as identified by an “X” superimposed over each failed cell 6. However, in this case (in contrast with that of FIG. 5D), all of the working battery cells 6 can still be connected because of the coupling via common points A, B and extra switches 7 provided: only the failed battery cells 6 are disconnected from the layer and the fault tolerance of the module 2 is improved. Indeed, this configuration allows for the physical removal of the failed battery cells from the battery module and their replacement with new ones during the operation. Once installed, the controller can connect the new cells in series with all the other cells (depending on the configuration of course). This method of operation is further illustrated in FIG. 12.

FIG. 7 is a virtualized view of a multi-layer module 2 according employing the configuration of FIG. 6. Each of the twenty layers comprises five battery cells 6 indicated by the spherical nodes. Within any given layer, each node is coupled to the neighbouring two nodes by conductors and switches 7 (not shown). Each node is also coupled to the two neighbouring common points, with the exception of the nodes of the top and bottom layers which are coupled to a single common point and to the positive/negative module terminals 4, 5. FIG. 7 illustrates how one or more current paths can be established across the module in an extremely flexible way, requiring only three switches 7 per node.

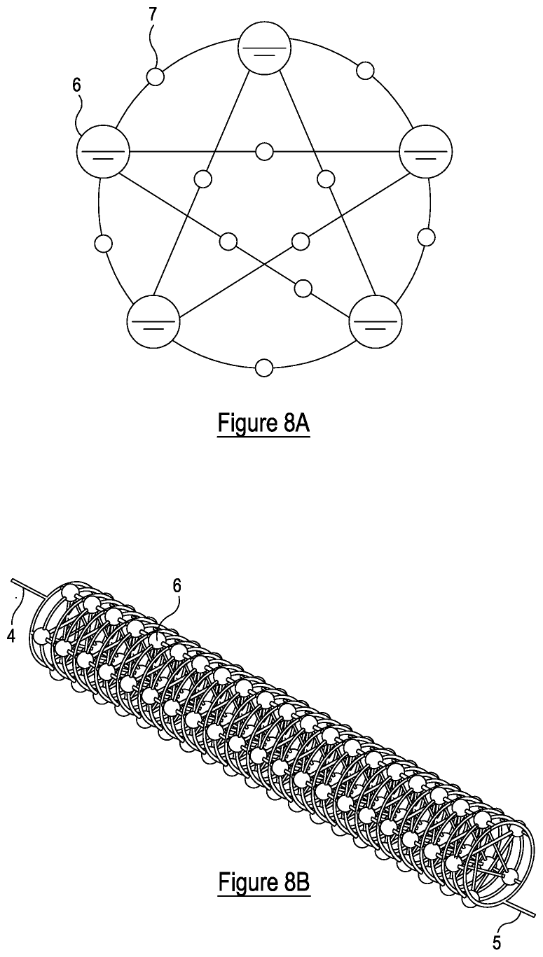

FIG. 8A illustrates schematically another example cell layer configuration. In this case, the layer comprises five battery cells 6 and the switches 7 are indicated by the circular nodes. Each battery cell 6 is coupled to every other battery cell 6 of the layer by conductors and switches 7. In other words, each battery cell 6 is no longer only coupled to the neighbouring cells 6 within a ring, but is also coupled to non-neighbouring cells 6 via switches 7. This layer topology provides an extremely flexible way to establish current paths inside the layer. If any of the battery cells 6 fail, regardless of whether the failed cells 6 are directly neighbouring or not, any of the remaining working cells can still be selectively connected. Therefore, fault tolerance of the layer is optimised.

FIG. 8B is a virtualized view of a multi-layer module according to an embodiment. Each of the twenty layers has the layer topology as illustrated in FIG. 8A. The battery cells 6 are indicated by the spherical nodes. The switches 7 are not shown in the Figure. Within any given layer, each cell is coupled to every other cell of the layer. Each cell is also coupled to the two neighbouring common points, with the exception of the cells of the top and bottom layers which are coupled to a single common point and to the positive/negative module terminals 4, 5. As outlined above, while the number of switches of the system is increased, the fault tolerance is optimised.

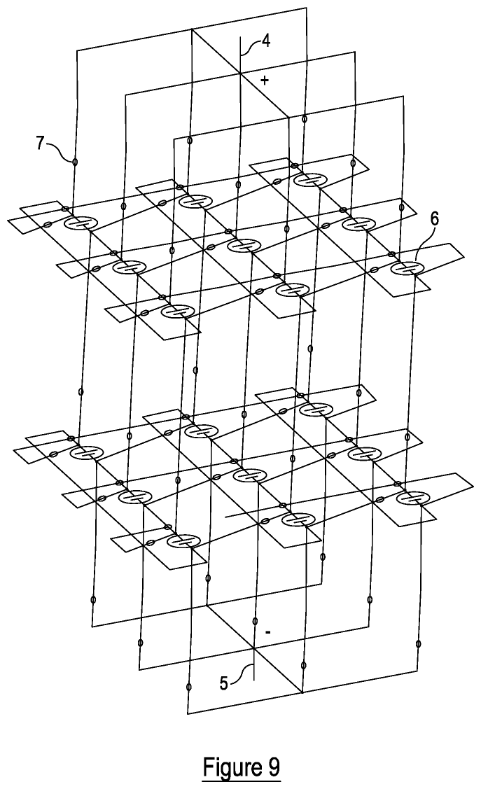

FIG. 9 illustrates yet another embodiment of a module 2 having two vertically stacked layers of battery cells 6, each with a multiple-ring topology. Each layer comprises nine battery cells 6, coupled by conductors and switches 7. The switches 7 are indicated by the small circular nodes. The nine battery cells 6 of each layer are arranged as six rings, wherein each ring comprises three battery cells 6, and each battery cell 6 belongs to two different rings. In other words, the rings are interconnected. Within a ring, the battery cells 6 are arranged such that a given battery cell 6 is coupled to two neighbouring battery cells 6, and each battery cell 6 is further coupled to a battery cell 6 of the neighbouring layer and to the positive or negative module terminals 4, 5. This multi-ring topology enables different current paths to be established across the module in an extremely flexible way.

It will be appreciated by the person of skill in the art that various modifications may be made to the above described embodiments without departing from the scope of the invention.

1. A battery system comprising a plurality of electrically coupled battery modules and a controller, each module comprising:
a positive module terminal and a negative module terminal for electrically coupling with terminals of other modules; and
one or more module layers each comprising
three or more battery cells arranged logically as a ring such that each battery cell has two neighbouring cells in the ring, and
switches between neighbouring cells of a ring and between the cells and the positive and negative module terminals,
the switches being configurable by said controller to electrically couple any two or more neighbouring battery cells of the ring in series between the positive and negative module terminals.

2. The battery system of claim 1, wherein current flows between neighbouring cells of a module layer in a single direction around the ring.

3. The battery system of claim 1, wherein the switches are configurable to disconnect one or more of the cells from a current path through the module layer.

4. The battery system of claim 3, wherein the controller is configured to detect failure of one or more cells and to configure said switches to disconnect the one or more failed cells from a current path.

5. The battery system of claim 1, wherein the switches are configurable to provide two or more parallel current paths through the module layer.

6. The battery system of claim 1, wherein the switches comprise, for each battery cell, a first switch being configurable to couple a positive cell terminal to the positive module terminal or a negative terminal of another module layer, and a second switch being configurable to couple a negative cell terminal to the negative module terminal or a positive terminal of another module layer.

7. The battery system of claim 1, wherein each switch is a two-way switch.

8. The battery system of claim 1, wherein each switch is a three-way switch.

9. The battery system of claim 1, further comprising a plurality of said module layers.

10. The battery system of claim 9, wherein the plurality of module layers are coupled in series.

11. The battery system of claim 9, wherein the plurality of module layers are coupled such that each battery cell of a given module layer is coupled in series, via the switches, to a corresponding battery cell of one or more adjacent module layers.

12. The battery system of claim 9, wherein the battery system is configured such that common terminals of all of the cells of a layer can be connected, via said switches, to a common point.

13. The battery system of claim 1, wherein the switches are configurable by the controller to electrically couple two or more non-neighbouring cells of a ring between the positive and negative module terminals.

14. The battery system of claim 1 wherein one or more of the battery cells of a module layer belongs to two or more rings.

15. The battery system of claim 1 wherein each battery cell of a module layer is additionally coupled to one or more non-neighbouring cells via switches.

16. A method of operating a battery system, wherein
the battery system comprises a plurality of electrically coupled battery modules and a controller, each module comprising:
a positive module terminal and a negative module terminal for electrically coupling with terminals of other modules; and
one or more module layers each comprising
three or more battery cells arranged logically as a ring such that each battery cell has two neighbouring cells in the ring, and
switches between neighbouring cells of a ring and between the cells and the positive and negative module terminals, and
the method comprises configuring the switches, by means of the controller, to electrically couple all cells of the module, or all working cells, into a single series connected string of cells.

17. A method of operating a battery system, wherein
the battery system comprises a plurality of electrically coupled battery modules and a controller, each module comprising:
a positive module terminal and a negative module terminal for electrically coupling with terminals of other modules; and
one or more module layers each comprising
three or more battery cells arranged logically as a ring such that each battery cell has two neighbouring cells in the ring, and
switches between neighbouring cells of a ring and between the cells and the positive and negative module terminals, and
the method comprises configuring the switches, by means of the controller, to connect a given subset of the cells of the module into a series connected string of cells in order to provide a required voltage and current output from the module.

18. The method of claim 16, further comprising configuring the switches, by means of the controller, to disconnect one or more failed cells of a module layer from other cells of the layer, and physically replacing the one or more failed cells with one or more working cells.

19. The method of claim 17, further comprising configuring the switches, by means of the controller, to disconnect one or more failed cells of a module layer from other cells of the layer, and physically replacing the one or more failed cells with one or more working cells.
